(19) United States
(12) Patent Application Publication
(10) Pub. No.: US 2009/0308321 A1
(43) Pub. Date: Dec. 17, 2009

(54) Bird feeder capable of being hand held or mounted to a surface

(76) Inventor: Lisa Szczygiel- Durante, Thomaston, CT (US)

Correspondence Address: IRVING KESCHNER, 21535 HAWTHORNE BOULEVARD, SUITE 385, TORRANCE, CA, 90503, US

(21) Appl. No.: 12/157,943

(22) Filed: Jun. 16, 2008

(51) Int. Cl. A01K 39/02

(52) U.S. Cl. 119/72

(57) ABSTRACT

A hummingbird feeder sized to be held in the hand of a user, the feeder being attached to a non-porous surface via a suction type cup and positioned such that hummingbirds have access to the nectar within the feeder. The cup has a wire member that functionally holds the feeder and allows it to be removed and held in the hand of a user when desired.

### BACKGROUND OF THE INVENTION

1. Field of the Invention

The present invention relates to a bird feeder, preferably for hummingbirds, sized to be held in the hand of a user or mounted to a surface.

2. Description of the Prior Art

Hummingbirds are known for their ability to hover in mid-air by rapidly flapping their wings and their ability to maintain a position while drinking nectar from flower blossoms and have evolved in a manner that enables the bird to feed upon nectar deep within flowers.

When hummingbirds feed, its bill is opened slightly, allowing the tongue to dart out and into the interior of flowers.

A number of feeding devices for hummingbirds have been disclosed in the prior art. For example, U.S. Pat. No. 2,570,733 to Thomas discloses a hummingbird feeder having a tube filled with nectar and an artificial flower with a hole therein coupled to a hole in the nectar containing tube. The flower is secured to the outside surface of the tube and is designed to attract hummingbirds so that they can feed through the hole in the flower and into the tube via the hole therein.

The feeder disclosed in the '733 patent is designed to be hung up outdoors only, the size thereof being too large to be placed in the hand/palm of a user.

What is desired is to provide a feeder that can be used for training hummingbirds to feed from the hands of a user and also having the capability for mounting to surfaces of various objects, such as porous walls.

### SUMMARY OF THE INVENTION

The present invention provides a feeder assembly that can be used both for training hummingbirds to feed from the hands of a user and for mounting to a surface. The feeder comprises a cylindrical member having open and closed ends and having a length sufficient to be positioned in the hand/palm of a user, the feeder being filled with fluid nectar. A removable cap/stopper having a small hole therein closes the open end of the cylindrical member and an artificial flower with a hollow center is inserted through the stopper hole allowing the hummingbird to have access to the nectar. A removable base, preferably a rubber suction cup, has a circular wire attached thereto which receives the cylindrical member. The cup is attachable to a non-porous surface, such as a window. The wire holds the feeder when the feeder is secured to the non-porous surface for training hummingbirds to feed from the feeder and when removed from the wire, to feed from the cylindrical member held in the hand of a user.

A hook can be provided to place the feeder on tree branches, other garden items or for attaching to porous surfaces.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view of the feeder of the present invention;

FIG. 2 is a sectional view of the feeder shown in FIG. 1;

FIG. 3 is a cross-sectional view along line 3-3 of FIG. 2;

FIG. 4 illustrates how the feeder of the present invention is held in the hand of a user;

FIG. 5 is a perspective view of the cap used to attach the feeder to a non-porous surface;

FIG. 6 illustrates the feeder of the present invention secured to a non-porous surface using the cap shown in FIG. 5; and

FIG. 7 is a cross-sectional view along line 7-7 of FIG. 6.

### DESCRIPTION OF THE INVENTION

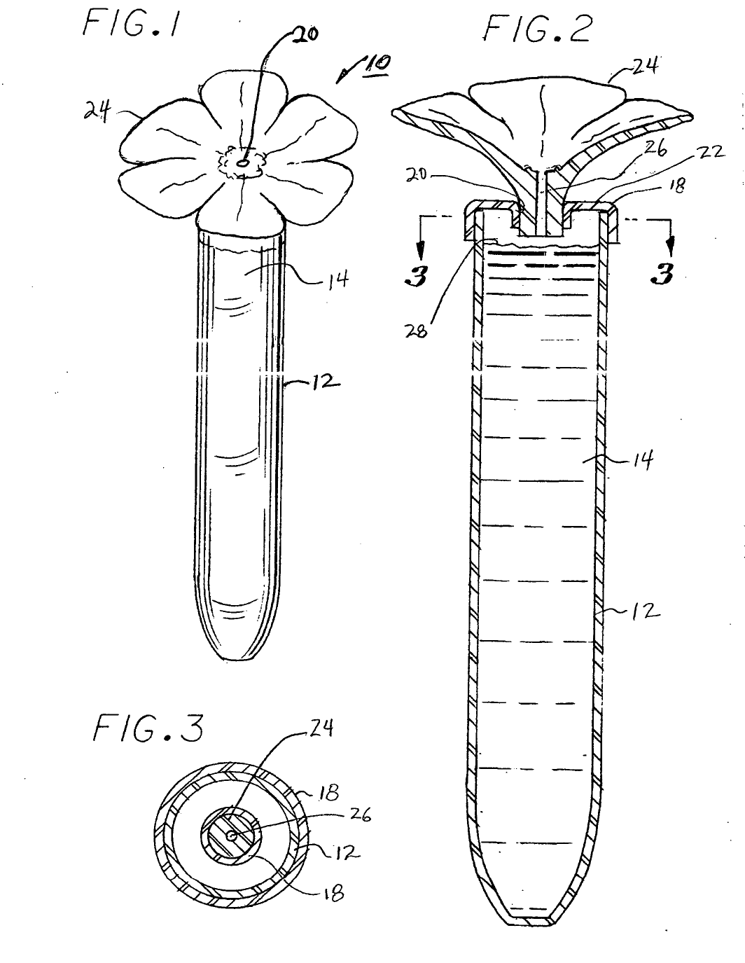

Referring now to FIGS. 1-3, a perspective view of the hummingbird feeder 10 utilized in the present invention is illustrated. Feeder 10 comprises a plastic or glass tubular member 12 having open and closed ends and having hummingbird nectar 14 contained therein.

A removable rubber cap/stopper 18 having a small hole 20 is positioned on the open end of member 12 in a manner to maintain nectar 14 within the member 12. The stem portion of silk or plastic flowers 24 has a hollow center 26 formed in the base thereof is inserted into the hole 20 and positioned adjacent the surface 28 of nectar 14.

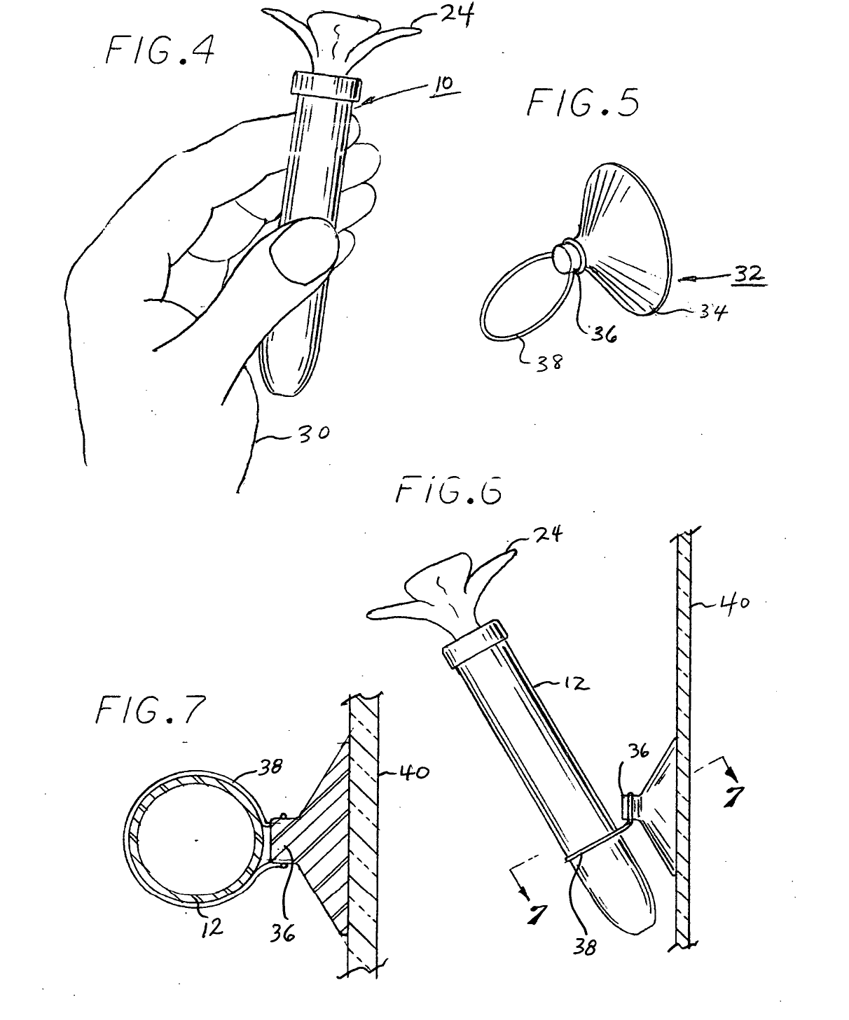

Tubular member 12 can be initially positioned upright (FIG. 2) until the level of nectar 14 is reduced approximately half way and then tilted away from the vertical (see FIG. 6) so that the hummingbirds can continue to access the nectar 14.

FIG. 4 illustrates feeder 10 held in the hand 30 of a user, one way to use the feeder of the present invention.

Referring to FIG. 5, removable base member 32 comprises rubber suction cup 34 having upper portion 36. A circular wire 38 is attached to portion 36 of cup 34. Base member 32 is attachable to non-porous surfaces, such as window 40 (FIG. 6). Note that base member 32 can be replaced with a hook type device to enable the feeder 10 to be placed on branches, trellises or other type surfaces. In this case, the hook will incorporate a circular member, similar to wire 38 to removably attach the feeder 10 to the hook.

The circular wire 38 (or hook equivalent) has two functions: the first is to friction-hold the feeder 10 when the cup 34 is secured to a non-porous surface to train the hummingbirds to feed from feeder 10; secondly, if the user chooses, the feeder 10 is removed from the wire 38 and used for hand feeding hummingbirds.

The present invention is used to attract hummingbirds and train them to feed by hand after becoming familiar with the feeder when attached to a surface. Thereafter, feeder 10 can be removed from its holder and held in the hand of a user.

Note that feeder 10 need not be removed from wire 38 and be hand-held, the feeder 10 can remain secured to the porous or non-porous surfaces noted above and other garden type items and function as a standard feeder.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A hummingbird feeder assembly comprising:
a tubular container closed at the bottom and opened at the top, said container having liquid food therein and sized to be held in the hand of a user;
a member positioned within the opening formed in the top of the container to enclose the food within the container, a hole being formed in said member;
a flower shaped member having a hollow center, said flower shaped member being inserted into the opening formed in said enclosing member; and
means for coupling said feeder to a non-porous surface, said feeder being removably engaged with a circular holder formed on said coupling means.

2. The feeder assembly of claim 1 wherein the length of said container is in the range between 2.5 inches and 4.5 inches.

3. The feeder assembly of claim 1 wherein said feeder is frictionally engaged with the interior surface of said circular holder.

4. A hummingbird feeder comprising:
a tubular container closed at the bottom and opened at the top; said container having liquid food therein and having a length so that it can be held in the hand of a user;
a stopper member positioned in the opening of said tubular container and having an opening formed therein; and
a flower shaped member having a hollow center, said flower shaped member being inserted into the opening formed in said stopper member.

5. The feeder of claim 4 wherein the length of said tubular container is in the range between 2.5 inches and 4.5 inches.
